(19) United States
(12) Patent Application Publication
(10) Pub. No.: US 2026/0223020 A1
(43) Pub. Date: Jul. 30, 2026

(54) RADIO ACCESS NETWORK RESILIENT DISTRIBUTED TIME SYNCHRONIZATION

(71) Applicant: AT&T Intellectual Property I, L.P., Atlanta, GA (US)

(72) Inventors: Joseph Soryal, Glendale, NY (US); Neel Patel, Short Hills, NJ (US); Jitendra Patel, Dardenne Prairie, MO (US)

(73) Assignee: AT&T Intellectual Property I, L.P., Atlanta, GA (US)

(21) Appl. No.: 19/039,309

(22) Filed: Jan. 28, 2025

(51) Int. Cl. H04W 56/00

(52) U.S. Cl. CPC H04W 56/001

(57) ABSTRACT

Aspects of the subject disclosure may include, for example, collecting timing information from one or more user equipment (UE) devices in a radio access network, establishing an accurate timing signal based on the timing information from the one or more UE devices, and providing, to network equipment serving the radio access network, the accurate timing signal as an alternative timing signal for synchronized operation of the radio access network in case of failure of a network timing signal. Other embodiments are disclosed.

### FIELD OF THE DISCLOSURE

The subject disclosure relates to a resilient time distribution system and method to provide resiliency in a radio communications network.

### BACKGROUND

Radio devices in a given area must have their timing closely synchronized for reliable operation. However, current time synchronization techniques can be vulnerable to attacks and may not be fully reliable.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communications network of FIG. 1 in accordance with various aspects described herein.

FIG. 2B is a block diagram illustrating a conventional timing distribution technique for a communications network.

FIG. 2C is a functional block diagram illustrating a timing verification engine in accordance with various aspects described herein.

FIG. 2D depicts an illustrative embodiment of a first method in accordance with various aspects described herein.

FIG. 2E depicts alternative embodiments for performing step 250 in FIG. 2D, in accordance with various aspects described herein.

FIG. 2F is a block diagram illustrating a second example, non-limiting embodiment of a system functioning within the communications network of FIG. 1 in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for a resilient distributed time synchronization system for radio access networks, which enhances timing accuracy and reliability by utilizing time verification engines (TVEs) embedded in network elements like baseband units (BBUs) and remote radio units (RRUs). These TVEs collect timing information from user equipment (UE) devices and establish an accurate timing signal, which serves as an alternative or primary timing reference in case of network timing signal failure. The TVE can reside anywhere in the network, on any platform where there is compute resources available such as user equipment (UE), in the cloud, etc. Moreover, the TVE can be a software element such as a microservice, a function as a service (FaaS), a virtual element, etc,, or a hardware element, or a combination between hardware elements and software elements. Additionally, the system can leverage auxiliary timing sources, such as the power grid, and employ advanced error detection and synchronization techniques to ensure robust and secure network operations. Other embodiments are described in the subject disclosure.

One or more aspects of the subject disclosure include collecting timing information from one or more user equipment (UE) devices in a radio access network, establishing an accurate timing signal based on the timing information from the one or more UE devices, and providing, to network equipment serving the radio access network, the accurate timing signal as an alternative timing signal for synchronized operation of the radio access network in case of failure of a network timing signal.

One or more aspects of the subject disclosure include receiving timing information from user equipment (UE) devices in a time division duplex (TDD) radio access network, the timing information based on a reliable timing signal received by the UE devices at locations of the UE devices, establishing an accurate timing signal based on the timing information from the UE devices, the accurate timing signal, the accurate timing signal being established with sufficient time synchronization and phase synchronization for reliable radio communication in the TDD radio access network, and providing, to a network element of the TDD radio access network, the accurate timing signal, the accurate timing signal available to the network element as an additional timing reference or as a primary timing reference in case of a failure of a network timing signal, the network timing signal being received at the network element to establish synchronized timing for radio communication among elements of the TDD radio access network. The same principles may be applied to radio networks incorporating other communications protocols such as orthogonal frequency division multiplexing, and others which also require tight synchronization.

One or more aspects of the subject disclosure include querying user equipment (UE) devices for local timing information of the UE devices, wherein the UE devices operate in a radio access network served by a network element, receiving the local timing information from the UE devices, the local timing information including a local time based on a reliable timing signal and location information, determining, by the processing system, a location of the processing system, adjusting the local timing information according to the location information and the location of the processing system to establish an accurate timing signal, and providing the accurate timing signal to the network element for synchronizing timing of radio communications with the UE devices in the radio access network.

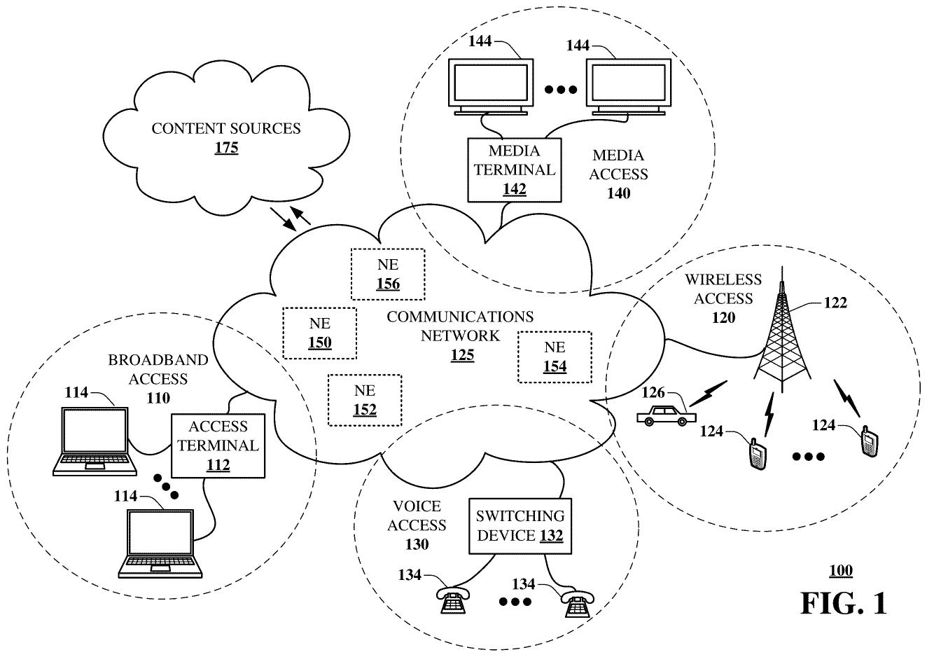

Referring now to FIG. 1, a block diagram is shown illustrating an example, non-limiting embodiment of a system 100 in accordance with various aspects described herein. For example, system 100 can facilitate in whole or in part using local time verification engines to establish reliable timing in a radio access network that may experience malicious signal jamming. The time verification engines establish the reliable based on timing information from unaffected user equipment. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

A radio access network (RAN) across a geographic area, such as wireless access 120, operates according to synchronized clock signals. Radio equipment in the RAN, including the base station or access point and user equipment (UE) devices such as mobile devices 124, should have their clocks tightly linked up and synchronized to adjust scheduling for uplink and downlink communications. The uplink corresponds to transmission from a UE to a base station; the downlink corresponds to a transmission from a base station to a UE. Radio communication systems such as fifth generation (5G) cellular and later systems, employ time division duplex (TDD) communications in which transmission and reception occur on the same radio channel by dividing time into separate time slots. TDD communications require very tight time and phase synchronization to ensure interoperation between various units in the RAN and to avoid interference between the uplink and downlink. As an example, between neighbor radios and beamforming requires synchronization on the order of 1. to 1.5 μs. That is, two radios sharing a frequency must be synchronized within 1 to 1.5 μs. In the case of carrier aggregation at a base station, system synchronization requirements are on the order of 3 μs. Other radio communication protocols such as orthogonal frequency division multiplexing (OFDM), code division multiple access (CDMA) and frequency division multiplexing, also require close synchronization in timing as well. Communication between two UE devices requires synchronization on the order of 10 μs.

Currently, communication systems such as the communications network 125 employ a reliable time source. One such time source is a global navigation satellite system (GNSS). The Global Positioning System (GPS) is one example of a GNSS. Signals transmitted by GNSS satellites for ground reception include very precise time information. However, incorporating a GNSS receiver at every site in a network may be considered an expensive solution. Moreover, such a solution may not be viable for indoor installations since satellite signals generally require a line-of-sight view of the satellite from the receiver and may be readily blocked if located indoors or even in the shadow of other structures.

Still further, GNSS signals may be vulnerable to spoofing and time alterations by dishonest actors. GNSS spoofing may involve transmitting a fake GPS signal that overpowers the genuine signals from satellites. This tricks the receiver into believing it's in a different location. Spoofing may be done by overpowering the GNSS signal by transmitting a stronger signal than the actual GNSS satellites. GNSS spoofing may also be done by transmitting signals that mimic the characteristics of genuine GNSS satellite signals. The result of a blocked or unavailable satellite signal, or a spoofed signal, can be a failure of synchronization of equipment of the radio access network.

Another source of reliable timing may be provided over a communications network to end points such as cells sites.

Aspects of the present disclosure can be implemented within the communications network 125 depicted in FIG. 1 by integrating a resilient distributed time synchronization system into the network elements (NE) 150, 152, 154, and 156. This system would collect timing information from user equipment (UE) devices, such as mobile devices 124, within the wireless access 120 area. The accurate timing signal established from this information would be provided to network equipment, such as the base station or access point 122, ensuring synchronized operation of the radio access network, particularly in cases where the primary network timing signal fails. This implementation enhances the reliability and security of the network's timing synchronization, crucial for maintaining seamless communication across various access technologies.

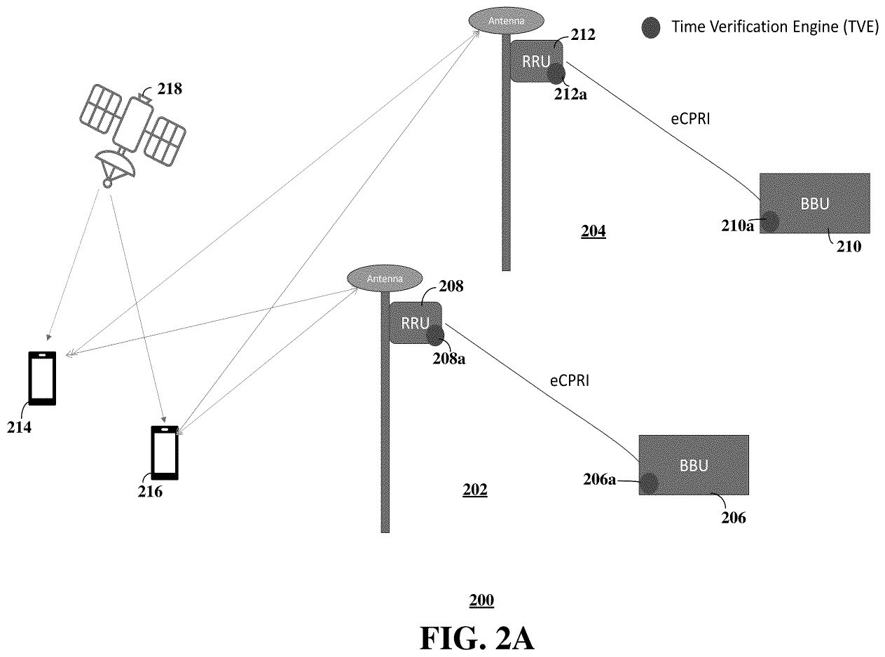

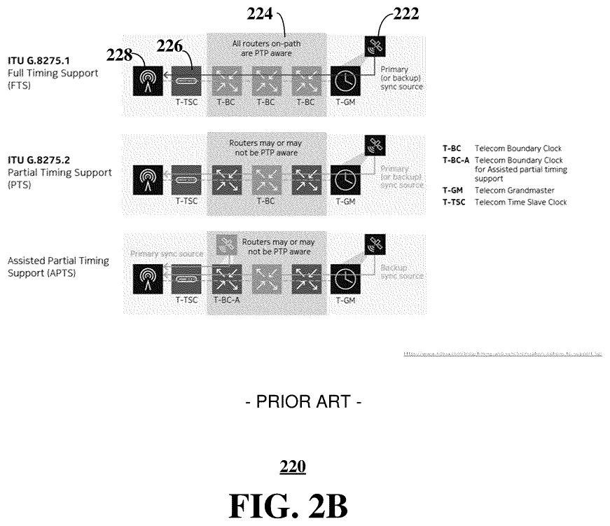

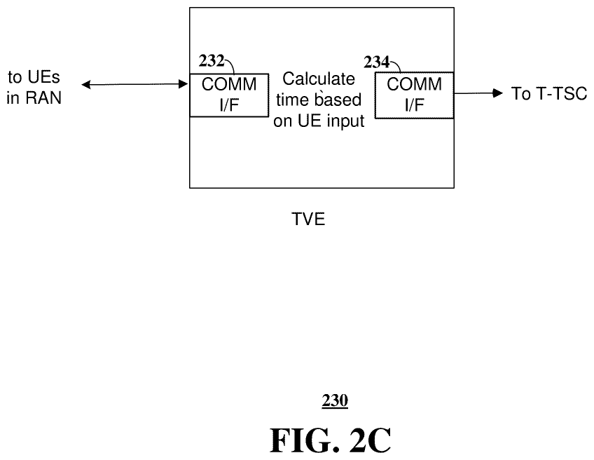

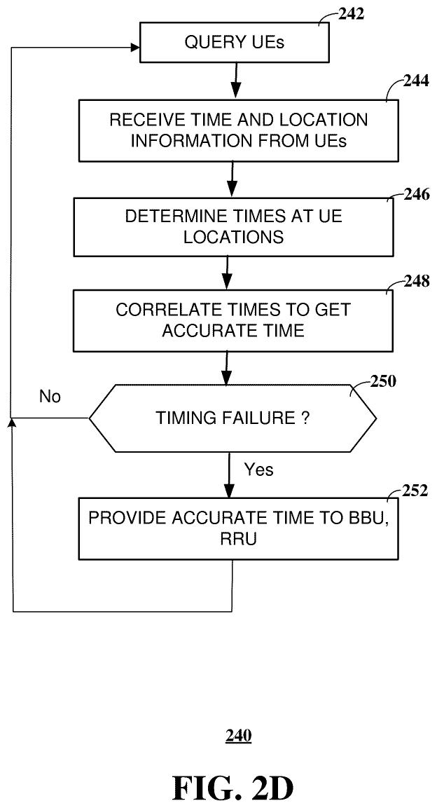

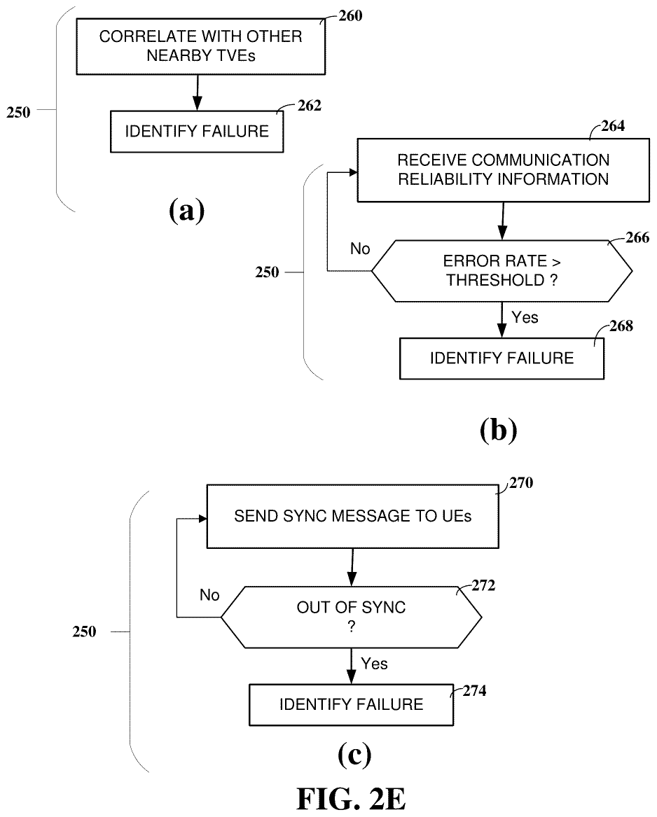

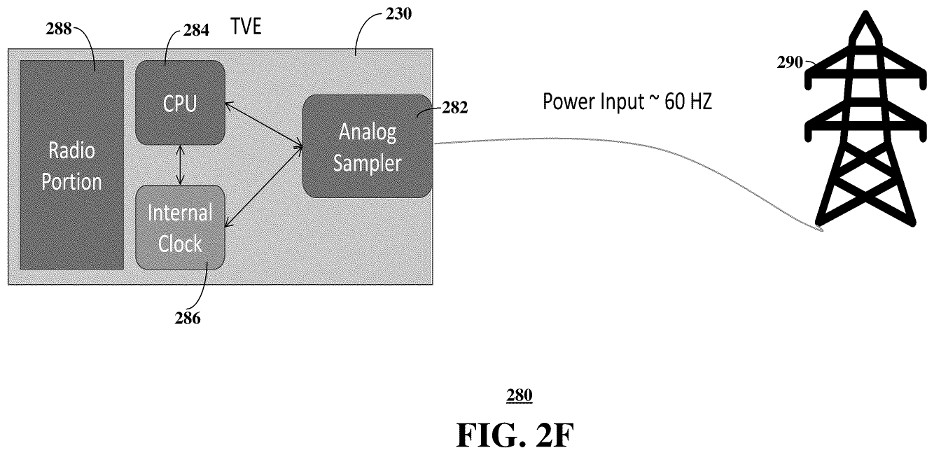

FIG. 2A is a block diagram illustrating an example, non-limiting embodiment of a system 200 functioning within the communications network of FIG. 1 in accordance with various aspects described herein.

FIG. 2A illustrates a system 200 within a radio access network, comprising multiple cell sites including cell site 202 and cell site 204. Each cell site includes a baseband unit (BBU) including in this example BBU 206 in the cell site 202 and BBU 210 in the cell site 204. Further, each cell site includes a remote radio unit (RRU) including in this example, RRU 208 in cell site 202 and RRU 212 in cell site 204. Each cell site may include a base station including one or more gNodeBs or gNBs to provide radio communication to a geographic area served by the cell site.

In general, a BBU such as BBU 206 handles core signal processing at the cell site 202 including encoding and decoding data, modulation and demodulation of signals for radio communication, and protocol handling. The BBU is in communication with other portions of the communications network such as a core network. The BBU generally supports one or more RRUs in a radio access network (RAN). The RRUs such as RRU 208 transmit and receives radio signals in communication with one or more user equipment (UE) device such as UE 214 and UE 216. The RRU 208 may connect to the BBU 206 via a high-speed fiber optic cable, for example.

In the RAN, UEs such as the UE 214 and the UE 216 are in radio communication with one or more RRUs or other equipment of a cell site. The UEs may include any suitable mobile or fixed radio communication devices including mobile phones, internet of things (IoT) devices and connected vehicles. For mobility, a UE may hand off communication from one base station or RRU to another.

The devices in the RAN generally must be in close time synchronization for reliable operation. A radio access network (RAN) such as the system 200 operating across a geographic area, such as wireless access 120 in FIG. 1, operates according to synchronized clock signals. Radio equipment in the RAN, including the BBU and the RRU of a base station or cell site and UE devices such as mobile devices 124 (FIG. 1), UE device 214 and UE device 216, should have their clocks tightly linked up and synchronized to adjust scheduling for uplink and downlink communications. The uplink corresponds to transmission from a UE to a base station or cell site; the downlink corresponds to a transmission from a base station or cell site to a UE.

Radio communication systems such as fifth generation (5G) cellular and later systems employ time division duplex (TDD) communications in which transmission and reception occur on the same radio channel by dividing time into separate time slots. TDD communications require very tight time and phase synchronization to ensure interoperation between various units in the RAN and to avoid interference between the uplink and downlink. As an example, between neighbor radios and beamforming requires synchronization on the order of 1.0 to 1.5 μs. That is, two radios sharing a frequency must be synchronized within a tolerance of 1 to 1.5 μs. In the case of carrier aggregation at a base station, system synchronization requirements are on the order of 3 μs. Communication between two UE devices requires synchronization on the order of 10 μs.

Reliable radio communications require precise and reliable clock signals shared among the radio devices in a RAN. A failure of clock synchronization can result in increased bit error rate (BER), lost packets, interference between users and dropped calls. If there is a timing mismatch, data packets can arrive out of order or be lost. This can lead to corrupted data, retransmissions to recover lost data, and decreased data rates. During a handover, mismatched timing can result in a dropped call.

Currently, communication systems such as the communications network 125 employ a reliable time source. One such time source is a global navigation satellite system (GNSS) such as GNSS 218 in FIG. 2A. The Global Positioning System (GPS) is one example of a GNSS. Signals transmitted by GNSS satellites for ground reception include very precise time information. Devices in the network, including BBUs, RRUs and UEs such as UE 214 and UE 216, may incorporate a GPS or other receiver to receive GNSS signals. Based on the signals, a network device determines a current time and a current geographic location of the device. However, incorporating a GNSS receiver at every site in a network may be considered an expensive solution. Moreover, such a solution may not be viable for indoor installations since satellite signals generally require a line-of-sight view of the satellite from the receiver and may be readily blocked if located indoors or even in the shadow of other structures.

Still further, GNSS signals may be vulnerable to spoofing and time alterations by dishonest actors. GNSS spoofing may involve transmitting a fake GPS signal that overpowers the genuine signals from satellites. This tricks the receiver into believing it's in a different location. Spoofing may be done by overpowering the GNSS signal by transmitting a stronger signal than the actual GNSS satellites. GNSS spoofing may also be done by transmitting signals that mimic the characteristics of genuine GNSS satellite signals. The result of a blocked or unavailable satellite signal, or a spoofed signal, can be a failure of synchronization of equipment of the radio access network.

Another source of reliable timing may be provided over a communications network to end points such as cell sites. FIG. 2B is a block diagram illustrating a conventional timing distribution technique for a communications network. FIG. 2B illustrates an example of definitions for precision timing protocol (PTP) 220. PTP is a protocol designed to synchronize clocks within a computer network with very high accuracy. As illustrated in the example, PTP uses a hierarchical structure with a grandmaster clock, designated T-GM, at the top of the hierarchy. The grandmaster clock is typically synchronized to an external time source like a GNSS signal from a satellite 222. The grandmaster clock sends time synchronization messages to other devices on the network, referred to as slave clocks. Examples include boundary clocks, designated T-BC in the figure, at routers of a router network 224.

Other examples of slave clocks include telecom time slave clocks 226, designated T-TSC in the figure. The slave clocks receive these messages and adjust their internal clocks accordingly. The telecom time slave clocks T-TSC 226 may be associated with use in telecommunications networks where precise timing is critical for various applications like 5G, optical networks, and synchronization of network equipment. The T-TSC 226 is designed to maintain accurate timekeeping even in challenging network environments with potential jitter, delays, and other disturbances. The T-TSC 226 receives time synchronization messages from a higher-level clock like a grandmaster clock T-GM or a boundary clock T-BC. Based on the received information, the T-TSC 226 adjusts its internal clock to match the time of the higher-level clock with high precision.

Other examples of slave clocks include Telecom Boundary Clock (Assisted Partial), designated T-BC-A in the figure. The Telecom Boundary Clock is specifically designed for use in telecommunications networks. It acts as an intermediary in the PTP network, receiving time information from upstream devices and distributing it to downstream devices. The “assisted partial: designation indicates that the T-BC-A has a degree of autonomy. The T-BC-A can utilize an external time source such as GPS or a local, reliable clock, as its primary time reference. However, it can also receive and process time information from other PTP devices in the network, allowing it to maintain synchronization even if the external time source is unavailable or unreliable.

Thus, the T-BC-A combines the benefits of both external time sources and PTP synchronization. The use of an external time source provides a backup and enhances the overall reliability of the timing system. The T-BC-A can adapt to different network configurations and time source availability.

T-TSCs are typically not designed to transmit synchronization information to other devices downstream. They generally provide reliable timing to end circuits 228. Such end circuits may include BBUs and RRUs at a cell site as shown in FIG. 2A. As indicated in FIG. 2B, PTP is defined in part in a standard referred to as ITU G8275.1 published by the International Telecommunications Union (ITU.) The standard ITU G8275.1 is based upon the IEEE 1588v2 Precision Time Protocol (PTP) published by the Institute of Electrical and Electronic Engineers, Inc.

In a mobility network such as system 200 of FIG. 2A, PTP uses network-based timing distribution to assist and maintain the timing during holdover periods when GNSS timing signals are unavailable. However, this solution may be susceptible to network delays and presents a single point of failure when installed by itself. Sophisticated attacks can manipulate the GNSS and the network together. For example, the GNSS can be interfered with via signal jamming and the PTP timing in the network can be interfered with via a denial-of-service (DoS) or other attack where traffic is directed to the RAN, flooding the RAN. for example.

In accordance with various aspects described herein, the BBUs and RRUs are equipped with respective time verification engines (TVEs) including (in FIG. 2A) TVE 206a at BBU 206, TVE 208a at RRU 208, TVE 210a at BBU 210, and TVE 212a at RRU 212. The respective TVEs are responsible for collecting timing information from user equipment (UE) devices 214 and 216. These UEs receive timing signals from a global navigation satellite system (GNSS) 218 or other reliable timing source. The TVEs process the timing information from the UE devices to establish an accurate timing signal, which is then used to synchronize the network equipment, ensuring reliable communication even in the event of a failure of the primary network timing signal. The RRUs and BBUs are interconnected via the evolved Common Public Radio Interface (eCPRI), facilitating efficient communication and coordination across the network.

FIG. 2C is a functional block diagram illustrating a time verification engine (TVE) 230 in accordance with various aspects described herein. In embodiments, the TVE includes a first communication interface 232 for communicating with UEs in a RAN and a second communication interface 234 for communicating with one or more T-TSC devices in the RAN. As illustrated in FIG. 2A, each network element such as BBUs and RRUs includes a TVE for communicating timing information. Each network element further has a T-TSC or similar timing signal for receiving PTP timing information as described in conjunction with FIG. 2B. The TVE 230 may include any suitable combination of hardware and software to perform the functionality described herein.

The first communication interface 232 may communicate with UEs using an application programming interface (API) of the UEs to request timing information. In particular, the TVE via the first communication interface 232 may communication timing and location information with the UEs and select one or more UE devices to provide timing information and location information for the UEs to the TVE. Each UE, in general, has a GPS receiver or other GNSS-enabled feature to enable the UE to determine a reliable system time. Further, based on the received GNSS signals, the UE can determine its own location with high precision. Location information is used by a wide variety of applications on a conventional UE. The location information may be shared by the UE with other devices or services such as the TVE 230. The TVE 230 can use API calls to request time and location information from UEs in the RAN. If the UE supports PTP communications, the API inquiry can be encapsulated in the PTP transport.

In operation, the TVE 230 may communicate with the UEs using the first communication interface 232 and receive current timing information from the UEs. The TVE 230 can calculate a current time based on the received current timing information from the UEs. The TVE 230 can provide reliable timing information via second communication interface 234 to T-TSC devices of network elements such a BBUs and RRUs in an RAN.

The TVE 230 calculates the time and distance between the UEs and BBU to calculate the accurate time and sends this time to the T-TSC. In some embodiments, the TVE 230 builds a database over time to correlate a UE's exact coordinates obtained by an accurate GNSS location API. Further, the TVE 230 knows its own location, for example based on location information stored at the network for BBUs and RRUs in the network and with which the TVE 230 is associated. The TVE 230 can get an accurate transmission time over a period of time to calculate the delay to add to the reported GNSS timing in the API. Thus, the TVE 230 receives time and location information for one or more UEs and saves this information in a database or updates the database as new information is received.

In embodiments, the TVE 230 may select which UEs in the RAN to rely on as a source of timing and location information. For example, the TVE 230 may discard outlier information from UEs for which a current time or location is outside a predetermined threshold. In some examples, UEs do not have current GNSS connectivity. For example, if GNSS signal jamming is occurring to affect the BBUs and RRUs of the RAN, some UEs may be close enough to the network components to experience the problem. UEs that do not have GNSS connectivity and which receive an API query from the TVE 230 for time and location information may decline the API query by a negative response or by sending no response.

Based on the location of a UE and the location of the TVE 230, the TVE 230 determines a time delay relative to the time received from the UE. The time delay corresponds to a time delay for transmission of the location and timing information from the UE to the TVE 230. If the TVE 230 receives UE timing information from multiple UEs, such as UE 214 and UE 216 in FIG. 2A, the TVE 23 can correlate the multiple received values to determine a best guess at accurate GNSS time. With knowledge of the time delay, the TVE 230 can adjust the received UE timing information to determine an accurate, reliable time. This accurate, reliable time can be forwarded to T-TSCs in the RAN.

In some embodiments, the TVE 230 may choose to use timing and location information only from relatively remote UEs. That is, some UEs are mobile and moving around the service area of a base station, gNodeB or RRU/BBU. Some UEs may be stationary such as some IoT devices. If the RRU or BBU is subject to signal jamming or other interference, UEs which are physically close to the RRU and BBU may also be subject to the interference. The TVE 230 may rely on an inference that such signal jamming or interference is concentrated on the area around the cell tower that is reporting signal interference. By choosing UEs that have a location more remote from the RRU and BBU, the TVE 230 may improve the likelihood of receiving reliable timing information from UEs which are not affected by the interference. In examples, the TVE 230 may set a threshold distance between the location of the TVE 230 and the location of a UE. If the UE is less than 500 meters from the location of the TVE 230, or a location of an RRU, BBU or other network element experiencing interference, the TVE 230 will ignore the timing and location information of that UE. The UE may be presumed to be unreliable. Any suitable threshold may be used, and dynamic thresholds may also be used depending on current circumstances.

The TVE 230 may be located in any suitable location, as suggested by FIG. 2A. In some examples, the TVE 230 may be collocated with the BBU and may include part of the operational components of the BBU. In other examples, for RAN configurations where the BBU is relatively far away from the RRU, the TVE 230 can reside in the RRU and update the T-TSC in the BBU and other parts of the network upstream over the eCPRI (evolved Common Public Radio Interface). eCPRI is an interface standard used in 5G networks. It defines the connection between a BBU and an RRU. Essentially, eCPRI represents s how the processing and radio parts of a cell site communicate. If the TVE 230 is located at the RRU, in this configuration, the TVE in the RRU may operate as the master coordinator for this particular cell site. As master coordinator, the TVE 230 coordinates with other adjacent cell sites.

The TVE 230 may identify a spoofed or fraudulent GNSS signal or unavailable timing in any suitable manner. In a first example, the TVE 230 may identify a timing mismatch between the time information reported by UEs and system timing reported by the PTP network. The timing mismatch may be compared against a timing threshold such as the synchronization required between neighbor radios and beamforming or synchronization on the order of 1 to 1.5 μs. If a mismatch is discovered, the TVE 230 may raise an alarm such as an automated alarm and may consult independently with the adjacent cell sites or RRUs that are fed by different T-TSC units. In effect, the TVEs in a geographical area could coordinate together to check for any GNSS or network-based GNSS spoofing or manipulation.

In another example, the TVE 230 is capable of detecting a manipulated GNSS feed by either passively monitoring the error rate between UEs and BBUs or actively via communicating, by the TVE 230, some passive communications to the UEs such as synchronization messages using the time provided by the T-TSC. The TVE 230 may monitor responses to determine if the UEs and adjacent cell sites are in sync or if the communications generate many errors due to an out of synchronization issue.

In some examples, independent TVEs such as TVE 230 can decide, collectively, to override the traditional GNSS signal. They may request authorization to do this, for example, after reporting conditions which may involve suspicious behavior or an increased or increasing error rate. In such a case, the TVEs then become the source of the synchronization after a manager authorization.

In additional examples, for enhanced functionality, a new process may be added to the mobile operating systems which controls operation of the UEs such as UE 214 and UE 216 (FIG. 2A). The new process may allow the UE to calculate the difference between the internal device clocks and GNSS and detect a sudden significant difference. For example, if the difference exceeds a threshold such as 1.5 μs, the modified UE may generate an alarm and provide the alarm signal or message to adjacent cell sites. This alarm or message may operate as a prompt to the TVEs active in the RAN to perform a double check of timing synchronization throughout the network.

In some other example embodiments, configurations include multiple TVE instances in the RRUs and BBU, similar to the example of FIG. 2A. The multiple TVE instances may cooperate and all coordinate together to determine best time calculations. In this configuration where there are multiple RRUs, the TVE instance in the BBU may perform the heavy computations for correlating the timings from different UEs and their reported time/location and comparing them to the coordinates of the RRUs to calculate the accurate timing.

When the TVE connects to a T-TSC, the TVE 230 acts as a telecom boundary clock, partial assisted or T-BC-A (FIG. 2B) wherein the TVE acts as an additional timing reference for the T-TSC. In other examples, the TVE 230 acts as a timing grandmaster T-GM (FIG. 2B) if there is no GPS signal at all available for a T-TSC at a network element such as a BBU or RRU.

In some examples involving GNSS signal jamming or unavailability of GNSS signals, one or more BBUs may detect the unavailability of GNSS signals. The BBU for a specific RAN site or sites would broadcast that the BBU is falling back to a distributed clock outsourcing from a TVE based on timing information received from a set of UEs. This information may be received over the network by other network elements such as RRUs and BBUs, in the RAN. In turn, the adjacent RAN network sites may attempt to use the same UEs used for the GNSS location and time API queries to increase the accuracy and efficiency between adjacent RAN sites.

Once the normal signal and configuration for the GNSS signal is restored, the network components may identify that the signal interference has ended. The normal, non-interference GNSS signal may be restored either via an onsite GNSSS receiver or over the network using PTP clock signals. The return to normal operation may be detected at the TVE via a monitoring interface to the T-TSC, for example. In response to detecting the return to normal operation, the TVE stops providing the timing to the T-TSC of the BBU, RRU or another component. However, in embodiments, the TVE still continues querying the UEs in the background to build up the database of timing and locations and to monitor the accuracy of the GNSS information.

Thus, the accurate timing signal by the established TVE 230 from the timing information received from the UEs may be provided to network equipment, such as the RRUs and BBUs at a base station or access point 122 (FIG. 1). This can ensure synchronized operation of the radio access network, particularly in cases where the primary network timing signal fails. This implementation enhances the reliability and security of the network's timing synchronization, crucial for maintaining seamless communication across various access technologies.

FIG. 2D depicts an illustrative embodiment of a first method 240 in accordance with various aspects described herein. FIG. 2D outlines method 240 for achieving accurate timing synchronization in a radio access network, as depicted in FIG. 2A for example.

The method 240 begins with step 242, where user equipment (UE) devices, such as UE 214 and UE 216, are queried for timing and location information. This step involves the Time Verification Engines (TVEs) 206a, 208a, 210a, and 212a, which are responsible for collecting this data from the UEs. The timing and location information may be obtained in any suitable manner. In exemplary embodiments, the TVEs use an API to request the desired information directly from respective UEs. This may include, for example, communicating with the UEs from a baseband unit (BBU) over the air interface via a control plane, for example. Further, the TVEs may selectively contact various UEs in the radio access network (RAN) based on any suitable standard such as proximity to a remote radio unit (RRU) on the assumption that more remotely located UEs may be less likely to be affected by any spoofing signal or other interference affecting the RRU or BBU.

In step 244, the time and location information is received from the UEs, which is crucial for determining the times at the UE locations, as shown in step 246. Any format may be used for communicating and receiving the time and location information. In some embodiments, the time and location information may be maintained in a database or other storage destination for ready retrieval by the TVE. Any other suitable information may be stored, as well.

The method then proceeds to step 248, where the timing information from multiple UEs is correlated to establish an accurate timing signal. This step is operative for synchronizing the network equipment, such as the BBUs and RRUs shown in FIG. 2A, ensuring reliable communication even in the event of a primary network timing signal failure. The TVEs enhance this synchronization by providing an alternative timing signal when the primary network timing signal is compromised.

The method checks for a timing failure in step 250. If a timing failure is detected, the accurate timing signal is provided by the TVE to the BBU and RRU, as indicated in step 252. The accurate timing signal may be provided in any suitable manner. In embodiments, the network elements such as the BBU and the RRU operate in conjunction with a precision timing protocol, examples of which are illustrated in FIG. 2B. The accurate timing signal from the TVE may serve as a telecom boundary clock (T-BC) signal or as a telecom boundary clock signal for assisted partial timing support (T-BC-A). If there is no other timing source available, the accurate timing signal from the TVE may serve as the telecom grandmaster (T-GM) clock for one or more network elements. This provision of an accurate timing signal by the TVE ensures that the network remains synchronized and operational despite any disruptions in the primary timing signal. This process is linked to the conventional timing distribution technique shown in FIG. 2B, where the precision timing protocol (PTP) is used to synchronize clocks within the network. The TVEs, as illustrated in FIG. 2C, enhance this synchronization by providing an alternative timing signal when the primary network timing signal is compromised.

Overall, method 240 of FIG. 2D demonstrates how the TVEs may be used to maintain accurate timing synchronization in the radio access network, even in the face of potential disruptions to the primary timing sources.

FIG. 2E depicts alternative embodiments for performing step 250 in FIG. 2D, in accordance with various aspects described herein. FIG. 2E provides alternative embodiments for identifying timing failures in a radio access network, as part of the method 240 depicted in FIG. 2D. FIG. 2E provides alternative embodiments that expand on features of step 250 of FIG. 2D, which involves checking for timing failures. In the context of FIG. 2A, where the Time Verification Engines (TVEs) 206a, 208a, 210a, and 212a are responsible for collecting and processing timing information, FIG. 2E outlines additional strategies for ensuring accurate timing synchronization.

In FIG. 2E(a), step 260 involves correlating timing information with other nearby TVEs to identify potential failures, as indicated in step 262. For example, an effort may be underway to interfere with GNSS signals in one area of a RAN, but the attack may be limited to the particular area. By comparing current timing information with TVEs nearby in the network, the TVE serving the particular area can determine if there has been fraudulent attempts made on the RAN. In an example, instead of a complete failure of the GNSS timing signal, the timing signal may be corrupted just enough to affect timing of communications in the network. As indicated above, a timing mismatch on the order of 1 to 1.5 μs may be adequate to cause serious disruption to the network. This collaboration among TVEs enhances the reliability of the timing signal by cross-verifying data across multiple network elements, such as the BBUs and RRUs shown in FIG. 2A.

FIG. 2E(b) involves receiving communication reliability information in step 264 and checking if the error rate exceeds a predefined threshold in step 266. For example, if there is a relatively minor timing mismatch in the RAN, the mismatch may manifest itself as an increased bit error rate, lost packets, and other failing key performance indicators (KPIs) of the network. If the error rate is above the threshold, for example, a failure is identified in step 268. Any suitable threshold may be set. This approach leverages the error rate as an indicator of potential timing issues, which can be crucial in environments where GNSS signals, as shown in FIG. 2A, may be compromised.

FIG. 2E(c) involves sending synchronization messages to UEs in step 270 and checking if the UEs are out of sync in step 272. The UEs may respond with any suitable message, such as reporting their current timing or by comparing timing information of the synchronization messages with current local timing at the UE. Any suitable mismatch criteria may be used. If a UE is out of sync, a failure is identified in step 274. This method actively engages with UEs to verify synchronization status, providing an additional layer of validation for the timing signal.

Overall, FIG. 2E complements the process in FIG. 2D by offering multiple mechanisms to detect and address timing failures, ensuring robust synchronization in the radio access network, as discussed with the inventor. These mechanisms are important for maintaining reliable communication, especially in scenarios where the primary network timing signal is compromised, as highlighted in the claims and the inventor's discussion.

While for purposes of simplicity of explanation, the respective processes are shown and described as a series of blocks in FIG. 2D and FIG. 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 2F is a block diagram illustrating a second example, non-limiting embodiment of a system 280 functioning within the communications network of FIG. 1 in accordance with various aspects described herein. FIG. 2F illustrates a system 280 that provides a second, alternative technique for achieving accurate timing synchronization in a radio access network, complementing the systems shown in FIG. 1 and FIG. 2A. The system 280 incorporates a time verification engine (TVE) 230, which includes several components including, in this example, an analog sampler 282, a central processing unit (CPU) 284, an Internal Clock 286, and a radio portion 288. The TVE 230 is connected to a power input 290, which receives a 60 Hz electric power signal from the electric power grid.

In the second embodiment exemplified by system 280, components of a RAN such as a BBU are housed in a cabinet located, for example, next to a cell tower that supports an RRU. In this example, a 60 Hz power source at the cabinet that houses the equipment such as the BBU is used as an auxiliary timing synchronization source.

Electric power utilities are known to use GNSS signal for time synchronization. Generally, in the United States, electric power is distributed at various voltages and a 60 Hz signal. Other jurisdictions may use other frequencies such as 50 Hz. The power grid is being used today to sync a variety of applications and systems with an accuracy of up to 2 milliseconds.

Radio access network equipment may use the power grid signal for synchronization. There are three power grid systems in the US, so RAN sites in the same vicinity are likely connected to the same grid. The electric power signals on the grid are synchronized to the same 60 Hz frequency. However, the accuracy of 2 ms is generally inadequate for synchronized operation in a RAN. As noted, timing accuracy on the order of 1 to 1.5 μs is more typically required for reliable communication in a RAN.

In accordance with aspects described herein, though, the RAN may be adapted to include one or more TVEs. The one or more TVEs such as the TVE 230 may be connected to the power grid to respond to the 60 Hz electric power signal. The TVE 230 is then operative to sample the electric power signal at a variable preconfigured sampling rate to obtain the accuracy required for the 5G RAN and network requirements. Embodiments based on this may be established as a backup system in case all other systems (e.g., GNSS) fail in a wide area or are jammed so that timing signals are not available. All the neighboring cell sites are generally using the same power grid and are in synchronization until the GNSS and or PTP at the sites is restored.

During times of normal operation, when GNSS and PTP timing signals are available, the TVE 230 may calculate an average offset between the GNSS signal and received timing via the power line to be used during emergencies. The offset calculation may be done continuously as timing may change of drift over time. During such normal operation, the system including radio and telecommunications equipment and power transmission equipment, will be in synchronization. All the geographical area would be in synchronization, with the offset, with the power grid. Henceforth, the GNSS signal feeding the power grid and the UEs would use the internal clocks that were fed by the GNSS signal at some point before any failure occurred.

If the GNSS signal and other auxiliary system fail, the TVEs would agree collectively to use the power grid for synchronization. Each TVE then commands the UEs in the vicinity to synchronize with the BBUs in the vicinity using the TVEs clock signals. Synchronization may be maintained, enabling reliable communication among the components of the RAN, based on the timing signals developed based on the 60 Hz power signal and the calculated offset.

In the embodiment of FIG. 2F, the analog sampler 282 may operate with a frequency of 60 times per second for the incoming frequency of 60 Hz to reach 3600 segments a second. This corresponds to a timing accuracy 1/(3600) second or 278 μs. Similarly, sampling the 60 Hz signal at 6000 times per second would get to a timing accuracy of 2.7 μs. Further sampling rates can be selected to obtain an accuracy of 1 μs.

The CPU 284 operates to control overall operation of the TVE 230, including the sampling rate employed by the analog sampler 282. The internal clock 286 may be synchronized with other clocks in the RAN and may also serve as an input to the sampling rate of the analog sampler 282. The radio portion 288 of the TVE enables communication with other network components such as UEs as well as reception of GNSS signals when available.

This configuration enhances the resilience of the network's timing synchronization by utilizing the power grid as an auxiliary timing source, ensuring reliable operation even in the event of GNSS signal failure. The TVE 230's ability to leverage the power grid for timing information aligns with the claims and the inventor's discussion, providing a robust solution for maintaining synchronization in the radio access network.

In a third embodiment, the TVE 230 is equipped with a long-range communications module. An example is a radio module that implements Long Range Wide Area Network, abbreviated as LoRaWAN. LoRaWAN is a low-power, wide-area networking protocol designed for the Internet of Things (IoT). LoRaWAN enables wireless communication between battery-operated devices and the internet over long distances. LoRaWAN devices offer low power consumption, long-range including a service range exceeding the range of other wireless technologies like Wi-Fi or Bluetooth, depending on various factors. LoRaWAN uses the LoRa modulation technique, which is specifically designed for long-range, low-power communication. Devices transmit data to nearby gateways. Gateways forward the data to a network server, which then routes it to the intended destination (e.g., a cloud platform or a RAN network element.

In accordance with the third embodiment, a TVE 230 includes an IoT communications module which implements LoRaWAN. The LoRaWAN communications module is employed in the event of a jammed GNSS signal or other network timing failure. When a TVE determines that no GNSS signal is available (and no PTP backup is available, for example), the IoT communications module attempts to reach TVEs at other RAN sites that are outside the jammed area and get timing information from this remote and unimpacted RAN. It is assumed that the signal jamming is relatively local to particular radio access network or portion of such a RAN. Any suitable messaging or protocol may be specified to enable timing-related communications between the affected TVE and the remote, unaffected TVE.

The unaffected TVE at the unimpacted RAN respond to a timing query from the affected TVE. The response will include suitable timing information for use by the affected TVE to reestablish or maintain local synchronized timing at the impacted RAN. In embodiments, the unaffected, remote TVE adds a flag or other indicator to its transmission of the timing information. Flag or other indicator indicates that the timing is coming from an accurate clock based on a reliable timing source such as a GNSS signal. The affected TVE at the impacted RAN receives the timing signal and can synchronize the local RAN. The affected TVE can, in turn, feed the correct timing signal directly to other impacted RANs or TVEs.

In some embodiments, the TVE IoT communications modules which are used for sharing reliable timing information may be maintained secure from jamming or other interference. For example, the module may routinely change the frequency for communication of timing information and the message format, size, and frequency used for communication of the timing information to avoid detection by any malicious entity and be possible jamming.

Alternate embodiments of the subject matter of the disclosure may include several enhancements and variations to improve the system's robustness and adaptability. One embodiment could involve enhanced TVE coordination, where a centralized coordination unit aggregates timing data from multiple TVEs across different RAN sites, using machine learning algorithms to predict potential timing failures and optimize synchronization across the network. Another embodiment may feature adaptive sampling rates, allowing the TVE to dynamically adjust the sampling rate based on network conditions or detected anomalies, thereby improving timing accuracy and resilience.

Integration with IoT devices could also be considered, where IoT devices equipped with GNSS capabilities provide supplementary data to the TVEs, enhancing the robustness of the timing signal, especially in areas with dense IoT deployments. A hybrid timing source approach could be implemented, integrating multiple timing sources such as GNSS, power grid signals, and terrestrial radio signals to create a hybrid timing solution, allowing the network to switch between sources based on availability and reliability.

Advanced error detection mechanisms using AI may be employed in some embodiments to analyze error patterns and predict potential synchronization issues before they occur, allowing for proactive adjustments. Decentralized timing verification may be used in another embodiment, where timing verification tasks are distributed among UEs themselves, creating a decentralized network of timing checks that enhance overall reliability. Cloud-based synchronization could leverage cloud computing to offload complex timing calculations to cloud servers, reducing the processing burden on local network elements and allowing for more sophisticated synchronization algorithms.

Finally, security enhancements may be incorporated, such as using blockchain technology to verify the integrity of timing data exchanged between network elements, ensuring that only authenticated and tamper-proof data is used for synchronization. These alternate embodiments aim to enhance the resilience, accuracy, and security of the timing synchronization system in a radio access network, addressing potential challenges and leveraging emerging technologies.

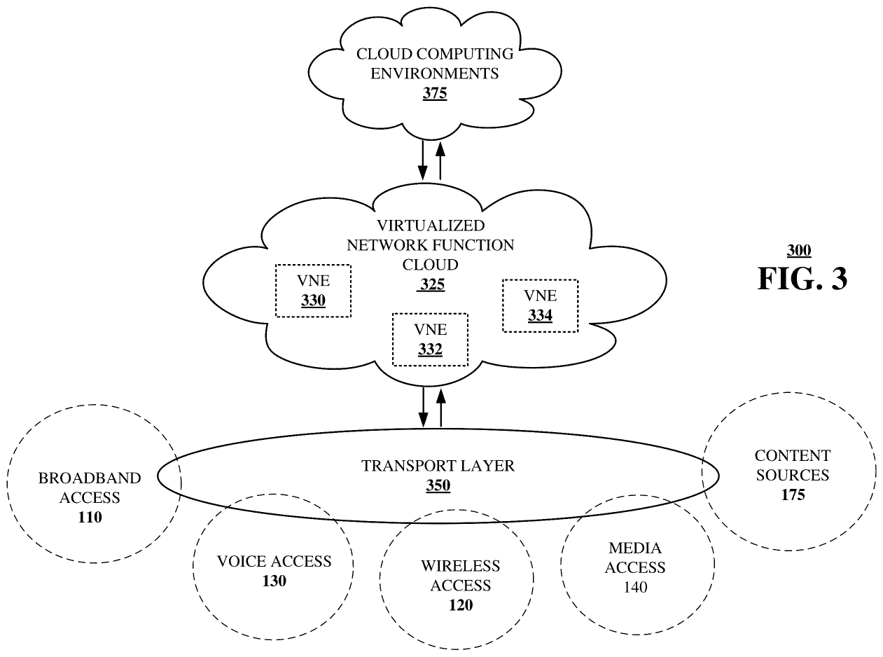

Referring now to FIG. 3, a block diagram is shown illustrating an example, non-limiting embodiment of a virtualized communication network in accordance with various aspects described herein. In particular a virtualized communication network 300 is presented that can be used to implement some or all of the subsystems and functions of system 100, the subsystems and functions of system 200, method 240, and system 280 presented in FIG. 1, FIG. 2A, FIG. 2B, FIG. 2C, FIG. 2D, FIG. 2E, FIG. 2F and FIG. 3. For example, virtualized communication network 300 can facilitate in whole or in part using local time verification engines to establish reliable timing in a radio access network that may experience malicious signal jamming. The time verification engines establish the reliable based on timing information from unaffected user equipment.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers - each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

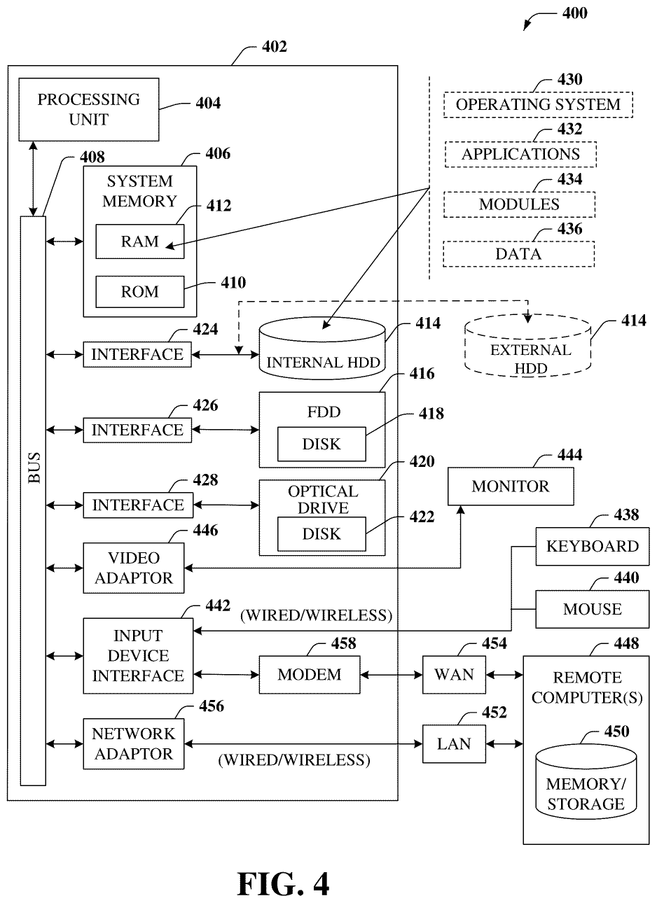

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part using local time verification engines to establish reliable timing in a radio access network that may experience malicious signal jamming. The time verification engines establish the reliable based on timing information from unaffected user equipment.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

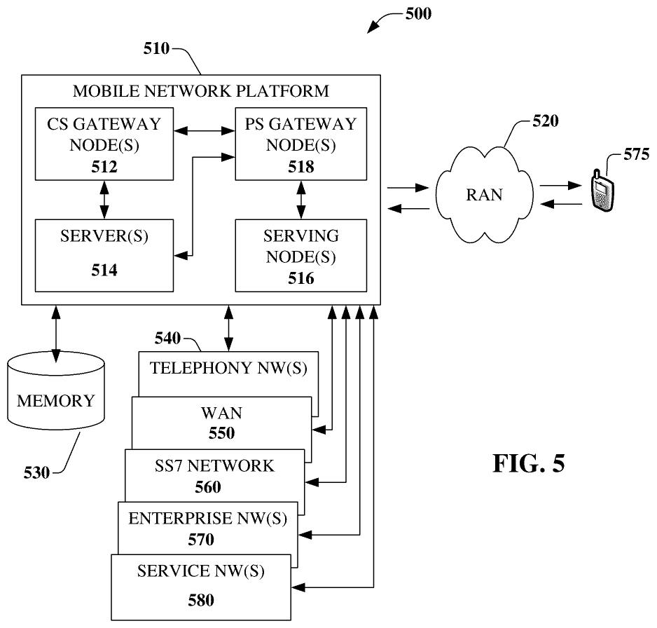

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part using local time verification engines to establish reliable timing in a radio access network that may experience malicious signal jamming. The time verification engines establish the reliable based on timing information from unaffected user equipment. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

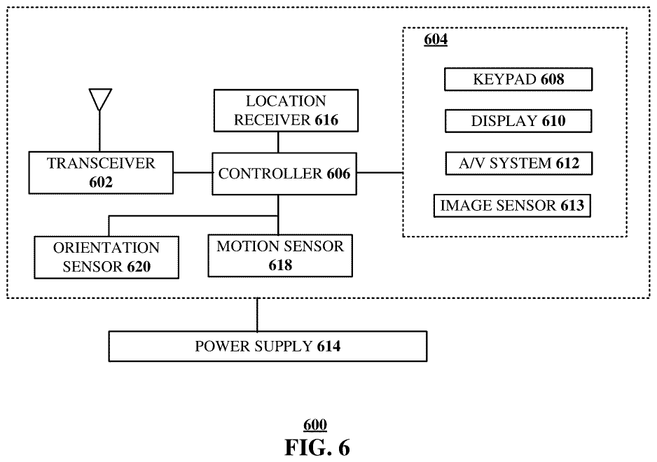

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part using local time verification engines to establish reliable timing in a radio access network that may experience malicious signal jamming. The time verification engines establishes the reliable timing based on timing information from unaffected user equipment.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth^{®}. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
collecting timing information from one or more user equipment (UE) devices in a radio access network;
establishing an accurate timing signal based on the timing information from the one or more UE devices; and
providing, to network equipment serving the radio access network, the accurate timing signal as an alternative timing signal for synchronized operation of the radio access network in case of failure of a network timing signal.

2. The device of claim 1, wherein the collecting timing information comprises:
querying respective UE devices of the one or more UE devices;
receiving, from the respective UE devices, respective local timing information determined by the respective UE devices; and
correlating the respective local timing information from the respective UE devices to determine the accurate timing signal.

3. The device of claim 2, wherein the operations further comprise:
receiving, from each respective UE device, a respective local time value at a current location of the respective UE device;
receiving, from each respective UE device, respective location information for the current location of the respective UE device;
determining, based on the respective local time value and the respective location information, a current accurate time value; and
establishing an accurate timing signal based on the current accurate time value.

4. The device of claim 3, wherein the operations further comprise:
determining a device location of the device;
determining, based on the respective location information, a respective distance from the device to each respective UE device; and
adjusting the respective local time value of each respective UE device according to the respective distance from the device to each respective UE device to establish the current accurate time value.

5. The device of claim 1, wherein the collecting timing information from the one or more UE devices in the radio access network comprises:
determining respective location information for the one or more UE devices;
determining a device location of the device;
determining respective distances for each UE device of the one or more UE devices, wherein the determining the respective distances is based on the device location of the device and the respective location information for the one or more UE devices; and
selecting, as selected UE devices, respective UE devices of the one or more UE devices, wherein the selected UE devices are selected based on respective distances for each UE device so that the selected UE devices are relatively remote from the device location and less likely to be affected by a jamming signal at the device location causing the failure of a network timing signal.

6. The device of claim 1, wherein the operations further comprise:
receiving, at the device, an electric power signal from an electric power grid;
selecting a sampling rate; and
sampling the electric power signal at the sampling rate to establish the accurate timing signal based on the electric power signal.

7. The device of claim 6, wherein the selecting a sampling rate comprises:
selecting the sampling rate to provide sufficient accuracy for reliable communication in the radio access network.

8. The device of claim 6, wherein the operations further comprise:
querying respective network equipment of a plurality of neighboring network equipment;
receiving, from the respective network equipment, respective local timing information determined by the respective UE devices based on local electric power signals from the electric power grid; and
correlating the respective local timing information from the respective network equipment to determine the accurate timing signal.

9. The device of claim 1, wherein the operations further comprise:
detecting a failure of the network timing signal, wherein the failure affects network devices of the radio access network in a vicinity;
communicating, according to a low power, wide area network protocol with remote network equipment outside the vicinity, the remote network equipment being unaffected by the failure, wherein the communicating comprises requesting timing information from the remote network equipment;
receiving, from the remote network equipment, a reliable timing signal; and
establishing the accurate timing signal based on the reliable timing signal from the network equipment.

10. The device of claim 9, wherein the receiving the reliable timing signal comprises:
receiving a message transmission from the remote network equipment, the message transmission including timing data corresponding to the reliable timing signal and a data flag, the data flag indicating that the reliable timing signal is based on a reliable timing source.

11. A non-transitory machine-readable medium, comprising executable instructions that, when executed by a processing system including a processor, facilitate performance of operations, the operations comprising:
receiving timing information from user equipment (UE) devices in a time division duplex (TDD) radio access network, the timing information based on a reliable timing signal received by the UE devices at locations of the UE devices;
establishing an accurate timing signal based on the timing information from the UE devices, the accurate timing signal, the accurate timing signal being established with sufficient time synchronization and phase synchronization for reliable radio communication in the TDD radio access network; and
providing, to a network element of the TDD radio access network, the accurate timing signal, the accurate timing signal available to the network element as an additional timing reference or as a primary timing reference in case of a failure of a network timing signal, the network timing signal being received at the network element to establish synchronized timing for radio communication among elements of the TDD radio access network.

12. The non-transitory machine-readable medium of claim 11, wherein the operations further comprise:
providing the accurate timing signal to a telecom-time slave clock (T-TSC) input of a baseband unit (BBU) of the TDD radio access network.

13. The non-transitory machine-readable medium of claim 12, wherein the operations further comprise:
receiving, with the timing information from the UE devices, location information and local time data for the UE devices;
adjusting the local time data according to the location information to establish a respective reliable local time for each respective UE device of the UE devices; and
correlating the respective reliable local time for each respective UE device to establish the accurate timing signal.

14. The non-transitory machine-readable medium of claim 12, wherein the operations further comprise:
detecting a failure of the reliable timing signal received by the UE devices; and
in response to the detecting the failure of the reliable timing signal, providing the accurate timing signal to the BBU as a backup timing reference during unavailability of the reliable timing signal.

15. The non-transitory machine-readable medium of claim 11, wherein the operations further comprise:
detecting a local unavailability of a global navigation satellite system as the reliable timing signal;
selecting remote UE devices, wherein the remote UE devices are selected based on location information received with the timing information from the UE devices, the remote UE devices being located a sufficient distance from the processing system to ensure the remote UE devices are not affected by the local unavailability of the global satellite navigation system; and
establishing the accurate timing signal based only on the timing information received from the remote UE devices.

16. A method, comprising:
querying, by a processing system including a processor, user equipment (UE) devices for local timing information of the UE devices, wherein the UE devices operate in a radio access network served by a network element;
receiving, by the processing system, the local timing information from the UE devices, the local timing information including a local time based on a reliable timing signal and location information;
determining, by the processing system, a location of the processing system;
adjusting, by the processing system, the local timing information according to the location information and the location of the processing system to establish an accurate timing signal; and
providing, by the processing system, the accurate timing signal to the network element for synchronizing timing of radio communications with the UE devices in the radio access network.

17. The method of claim 16, comprising:
receiving, by the processing system, a sampled signal, the sampled signal based on sampling an electric power signal received from a power grid powering the UE devices;
establishing, by the processing system, a backup timing signal based on the sampled signal; and
providing, by the processing system, the backup timing signal to the network element for synchronizing the timing of the radio communications in the radio access network when the accurate timing signal is not available.

18. The method of claim 16, comprising:
detecting, by the processing system, a failure of the reliable timing signal in a region including the UE devices;
receiving, by the processing system, a replacement reliable timing signal from a remote device, the remote device located in a region outside the region including the UE devices and not affected by the failure of the reliable timing signal; and
establishing, by the processing system, the accurate timing signal based on the replacement reliable timing signal from the remote device.

19. The method of claim 18, comprising:
detecting, by the processing system, a global navigation satellite signal as the reliable timing signal; and
detecting, by the processing system, absence of the global navigation satellite signal or unreliability of the global navigation satellite signal as the failure of the reliable timing signal.

20. The method of claim 18, wherein the receiving the replacement reliable timing signal from the remote device comprises:
receiving, by the processing system, timing data corresponding to the reliable timing signal and a data flag, the data flag indicating that the reliable timing signal is based on the reliable timing signal.
